(19) United States
(12) Patent Application Publication
(10) Pub. No.: US 2004/0261602 A1
(43) Pub. Date: Dec. 30, 2004

(54) Ring mute

(76) Inventors: Mark Matthew Shellhammer, Clarksburg, WV (US); Ellen Jane Shellhammer, Clarksburg, WV (US)

Correspondence Address: Mark M. Shellhammer, 135 Hall St., Clarksburg, WV, 26301, US

(21) Appl. No.: 10/601,536

(22) Filed: Jun. 24, 2003

(51) Int. Cl. G10D 9/06

(52) U.S. Cl. 84/400

(57) ABSTRACT

The ring mute is a mute made of sound absorbent material which is attached onto and around the rim of the bell of a brass musical instrument instead of inside the bell of the brass musical instrument. The ring mute attachment method creates no apparent air blow restriction or pitch change. This is due to the bell hole of the brass musical instrument not being blocked. The ring mute, as with all mutes increases musical expressivity. The position and construction creates a smooth, rounded, smoky, musical expression for brass musical instruments.

### BACKGROUND

This invention relates to other mutes in that it changes the timbre of a brass musical instrument but with no apparent change in air blow resistance or pitch. The ring mute differs from other preexisting mutes in that the ring mute fits onto and around the rim of the bell of a brass musical instrument expressively causing a smoother, more rounded, smoky sound.

The reason the ring mute was invented was due to the need for a quieter trumpet. Various mutes were tried in order to deal with the situation but depending on the mute used, the adjustment to the tuning slide to keep the trumpet in tune ranged from moderate tuning slide adjustment to large tuning slide adjustment (an example of large tuning slide adjustment would be the harmon mute). Being dissatisfied with having to adjust the tuning slide, a urethane foam ring was fashioned to fit onto and around the rim of the bell of a trumpet. Surprisingly not only did the ring dampen the sound, it changed the timbre to a smooth, rounded, smoky, musical expression with no apparent change in air blow resistance or pitch.

### DESCRIPTION OF RELATED ART

Conventionally, if a brass musician (for example trumpet player) wanted to express a round, smooth, smoky sound from the instrument, generally, two avenues were taken: Purchase a vintage trumpet (The Martin Company Committee B-flat Trumpet) which tends to have a smooth, rounded, smoky sound due to materials and design. The famous trumpet player Miles Davis who used the Martin Company Committee B-flat Trumpet would be an excellent example of the smooth, rounded, smoky sound); or use a flugelhorn.

FIG. 1 Vintage trumpet from around 1940's 1950's

FIG. 2 Flugelhorn

Although no mute on the market creates the sound of the ring mute, several mutes are available to assist the musician with added expressivity. All current mutes are designed to be placed into the bell of the brass musical instrument thus causing more air blow resistance and pitch change. Examples of such mutes are the harmon mute, the straight mute and the cup mute.

FIG. 3 Harmon mute

FIG. 4 Harmon mute with brass instrument

FIG. 5 Straight mute

FIG. 6 Straight mute with brass instrument

FIG. 7 Cup mute

FIG. 8 Cup mute with brass instrument NOVELTY, UTILITY AND NONOBVIOUSNESS

Novelty

The ring mute is novel in that instead of the mute plugging into the instrument by fitting inside the bell of the brass musical instrument, the ring mute fits onto and around the rim of the bell of the brass musical instrument. This is an important difference from all previous mutes since research suggests that no mutes to date go onto and around the rim of the bell of a brass musical instrument. Instead, all mutes go inside the bell of the brass musical instrument. This is akin to a male plug (traditional mutes) and a female receptor (the brass musical instrument).

Utility

The usefulness of the ring mute is found in the sound it produces. The unique sound (timbre) is altered to a smooth, more rounded, smoky expression musically with no apparent change in air blow resistance or pitch. The ring mute gives the brass musician a new and different choice among the choices of mutes used for musical expressivity.

Nonobviousness

The ring mute is both a surprising and significant development for individuals who use mutes with brass musical instruments in both the effect it achieves and how it is used. Mutes are used in brass musical instruments to add variety to the expression of the music and reduce the loudness of a brass musical instrument.

The ring mute adds a smooth, rounded, smoky effect to the music by reducing the sharpness of the sound (timbre), thus giving the auditory effect of a reduction in sound. This is a significant difference from the sound of all other mutes that fit into the bell of the brass musical instrument.

Visual Description

The ring mute is used by placing the ring onto and around the rim of the bell of the brass musical instrument. This results in no apparent air blow resistance for the musician. To date no other mutes work in this fashion or have quite this effect.

FIG. 9 Ring mute with ruler

FIG. 10 Ring mute with ruler

FIG. 11 Ring mute incision area

FIG. 12 Ring mute with trumpet

FIG. 13 Ring mute with trumpet

### SUMMARY OF THE INVENTION

It is therefore the object of the present invention (ring mute) to provide a means for new musical expressivity by way of a mute that has no apparent air blow resistance or pitch change. This does not exist in current day mutes. To accomplish the objective a ring of flexible, sound absorbent, urethane foam 1.25 inches×0.625 inches in diameter is utilized. On the outer side of the ring of flexible, sound absorbent, urethane foam a non-porous adhesive plastic strip is used with the adhesive side against the ring to reinforce the foam and to assist in creating a fit onto and around the rim of the bell of the brass musical instrument. On the inside area of the ring of flexible, sound absorbent, urethane foam a scalpel incision 0.25 inches deep is cut completely into and around the inner middle of the ring. This allows the rim of the bell of the brass musical instrument to fit inside the flexible, sound absorbent, urethane foam. The circumference of the ring mute will vary depending on the type of brass musical instrument used. The photographs provided under DESCRIPTION uses a B-flat trumpet as a means to more easily describe the invention. The ring mute can be used for any brass musical instrument as a means to expand musical expressivity.

### BRIEF DESCRIPTION OF THE DRAWINGS (DIGITAL PHOTOGRAPHS)

FIG. 1 is an example of a vintage Martin Company Committee trumpet circa 1940's to 1950's

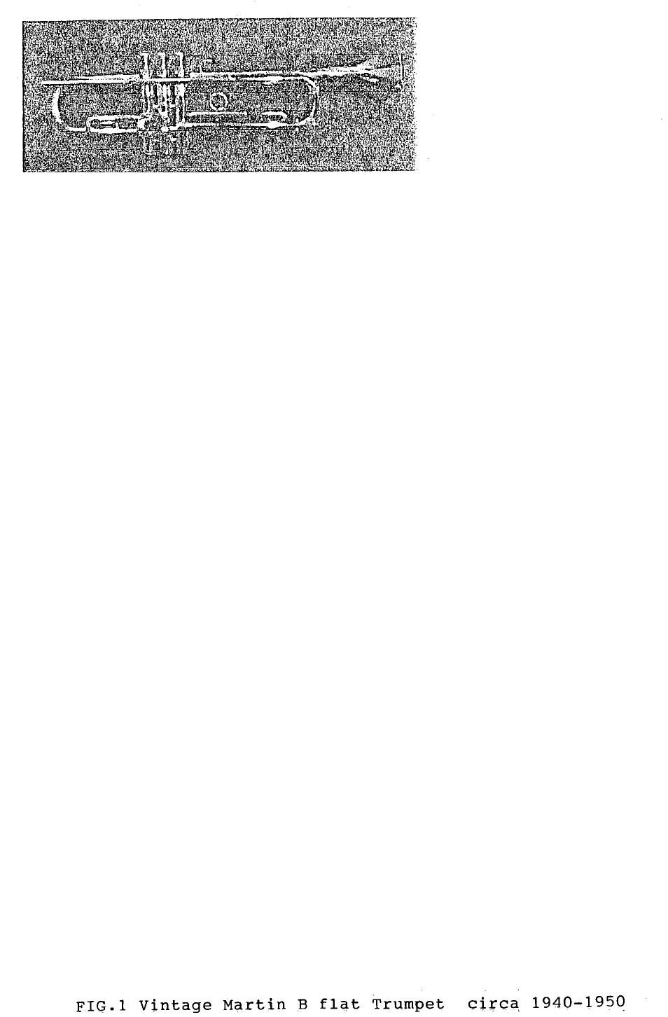

FIG. 2 is an example of a flugelhorn

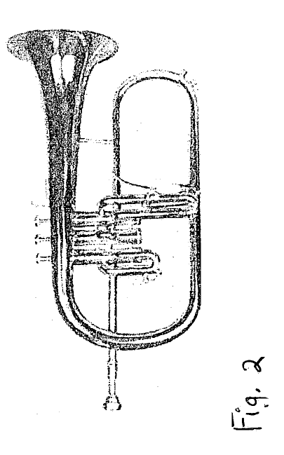

FIG. 3 is an example of a harmon mute used for trumpet

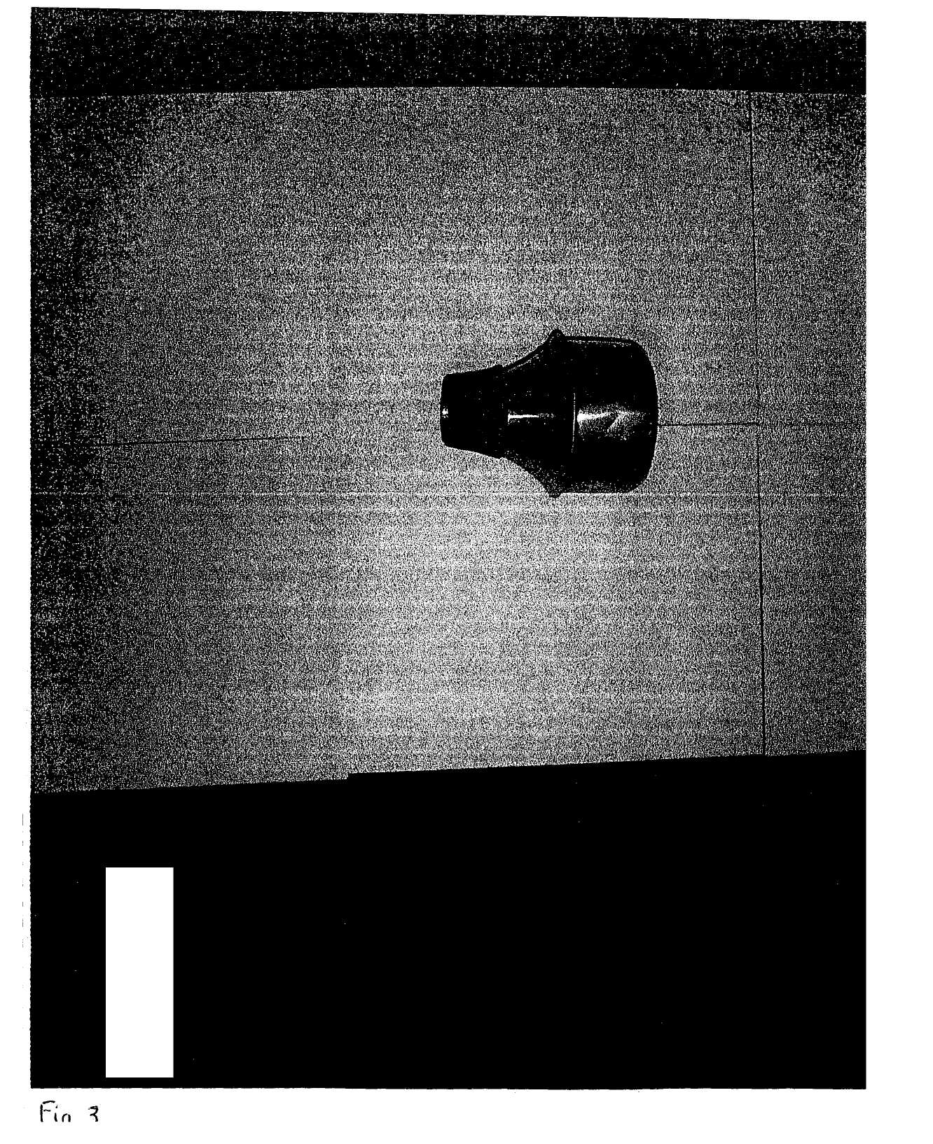

FIG. 4 is an example of a harmon mute placed inside a B flat trumpet

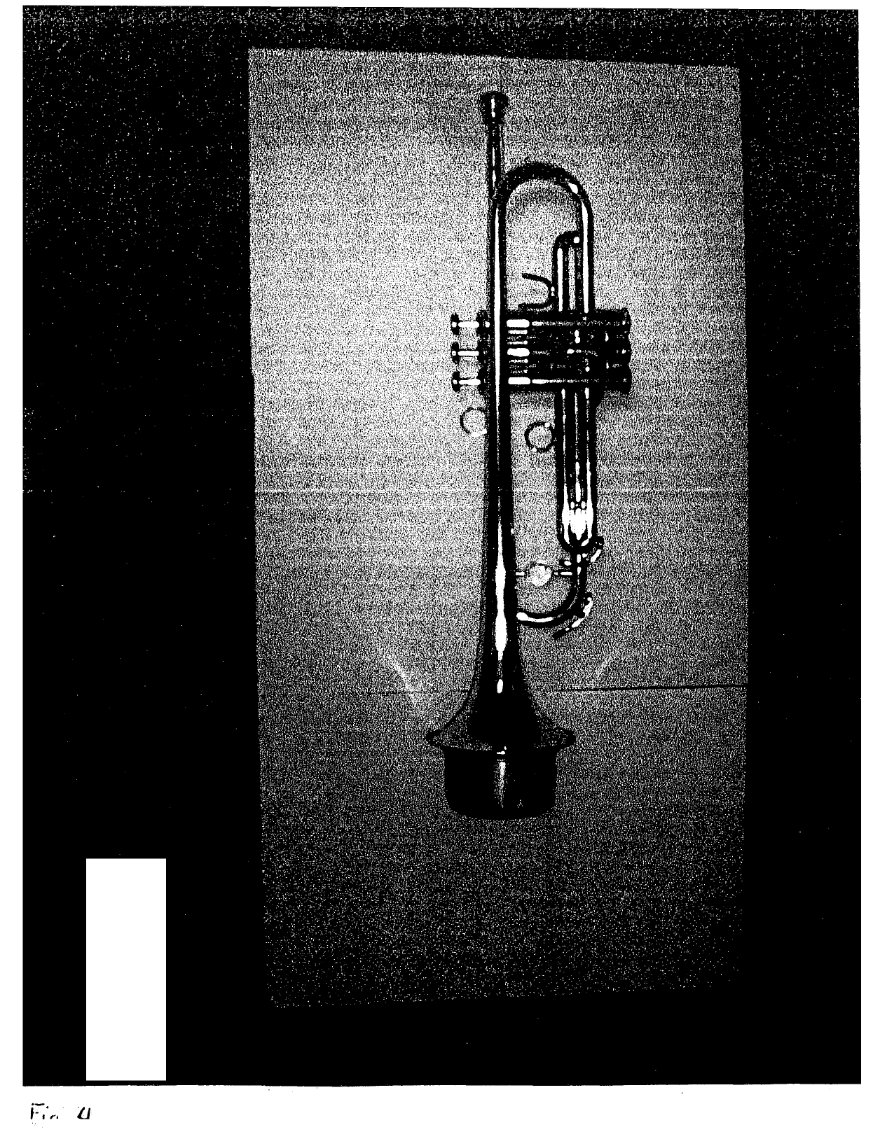

FIG. 5 is an example of a straight mute used for trumpet

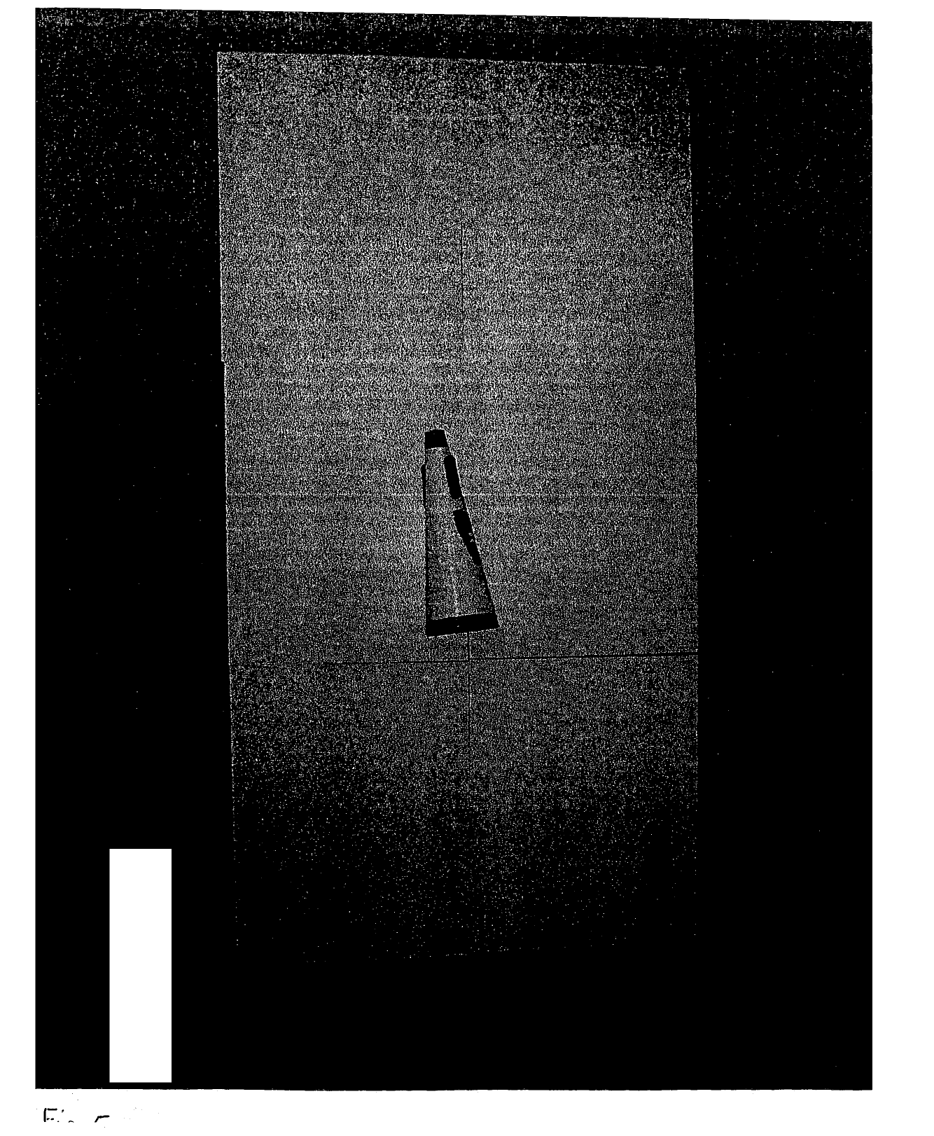

FIG. 6 is an example of a straight mute placed inside a B flat trumpet

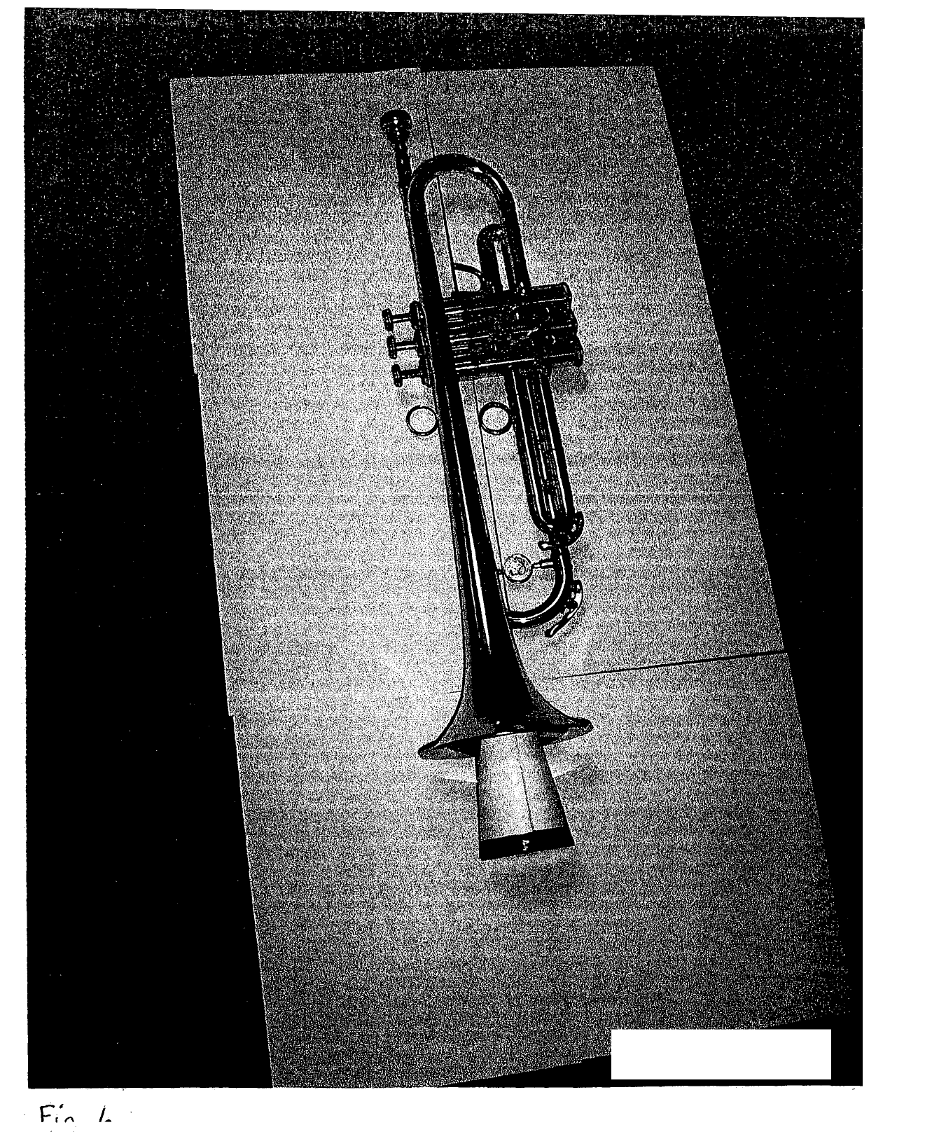

FIG. 7 is an example of a cup mute used for trumpet

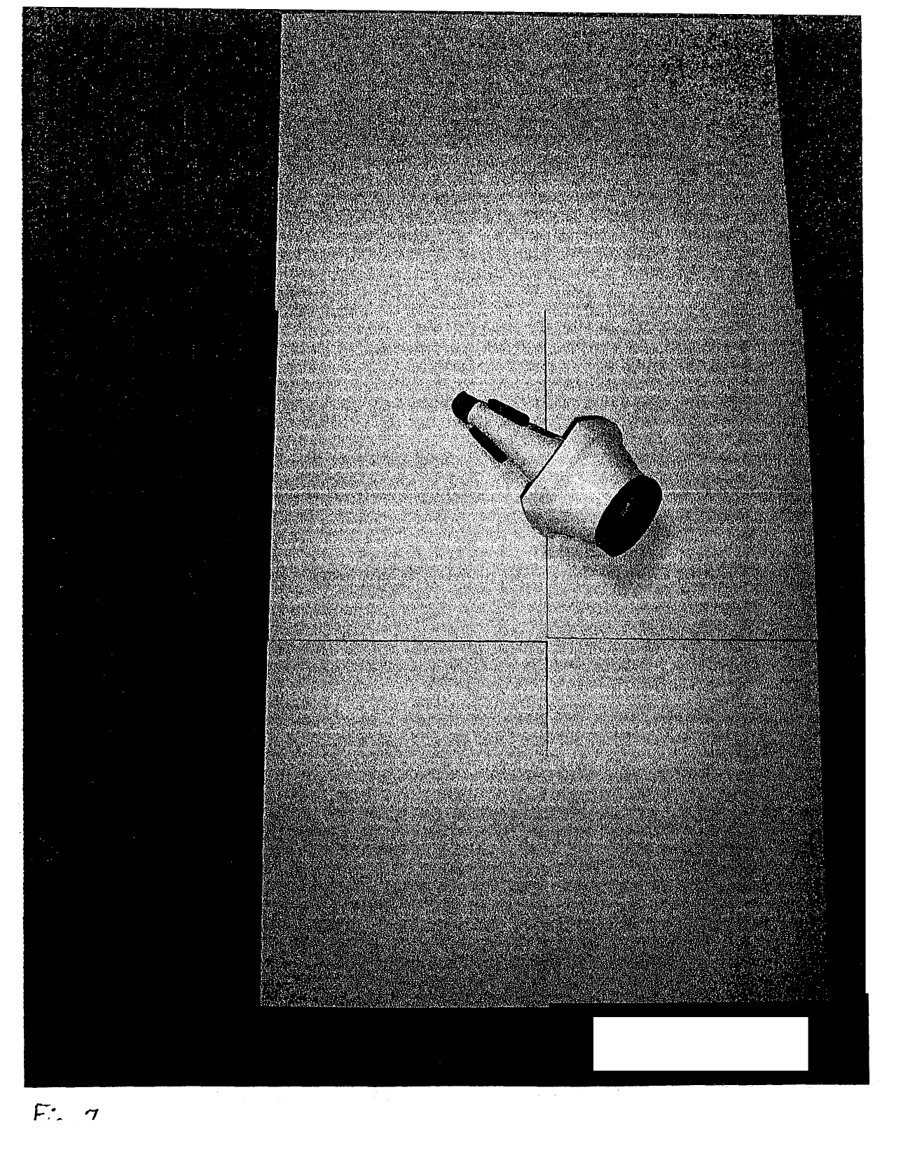

FIG. 8 is an example of a cup mute inside a B flat trumpet

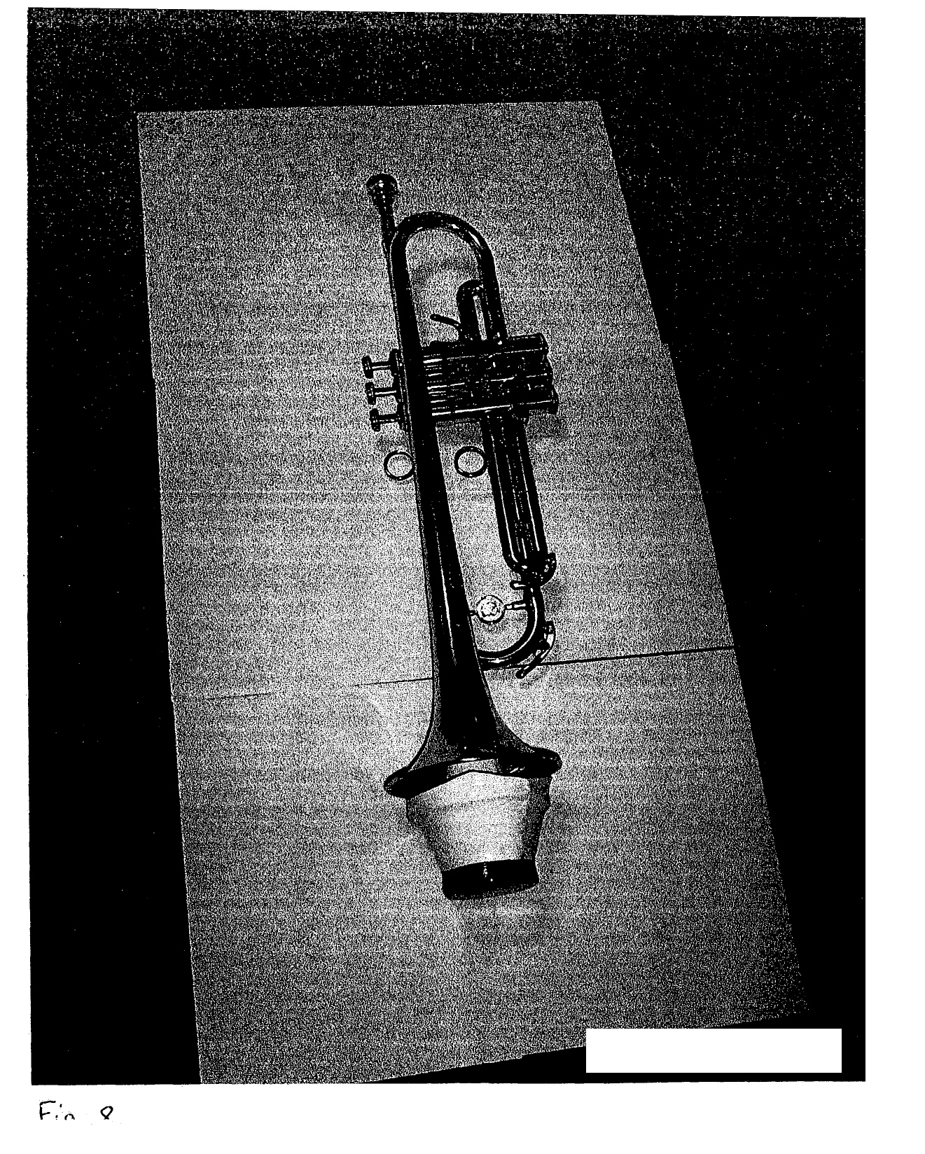

FIG. 9 is a digital photograph of the ring mute positioned in a horizontal manner

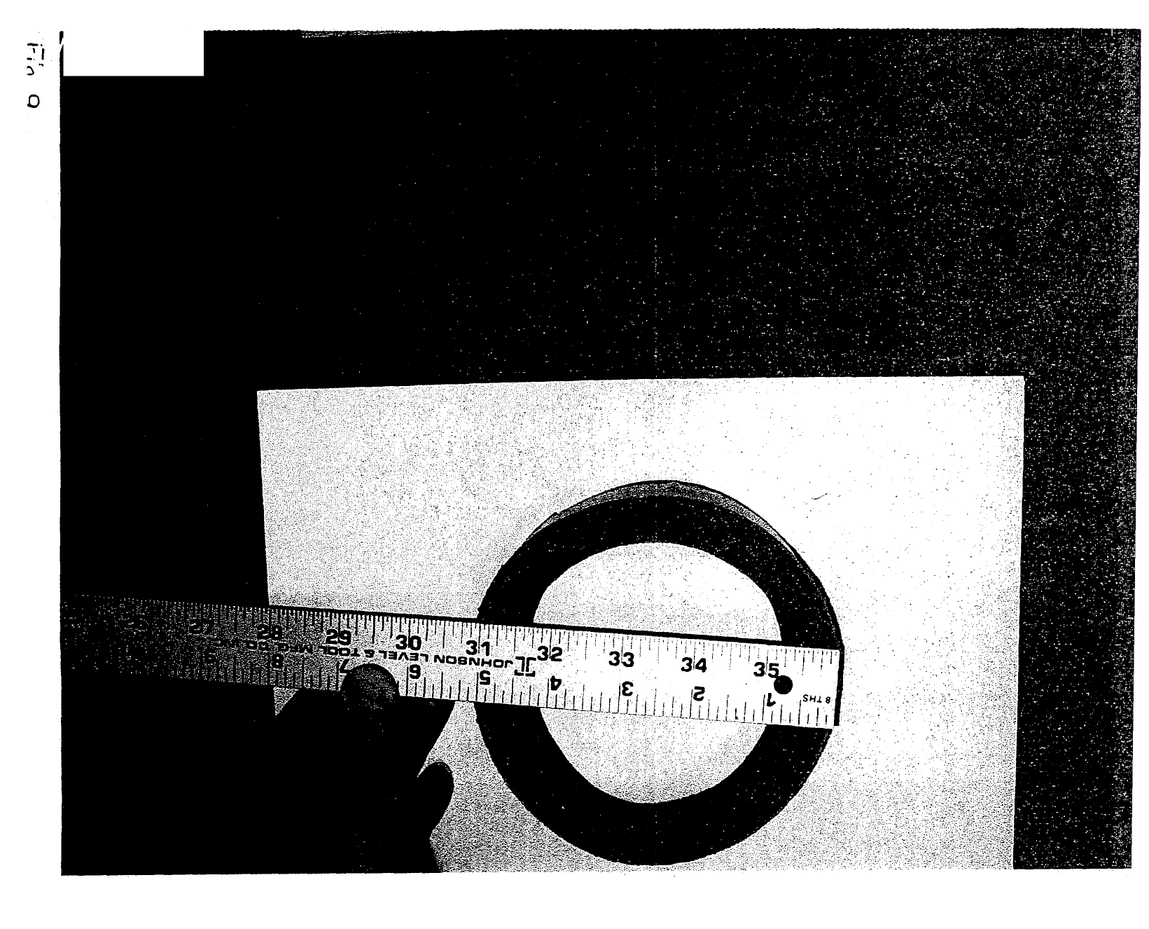

FIG. 10 is a digital photograph of the ring mute positioned in an upright manner

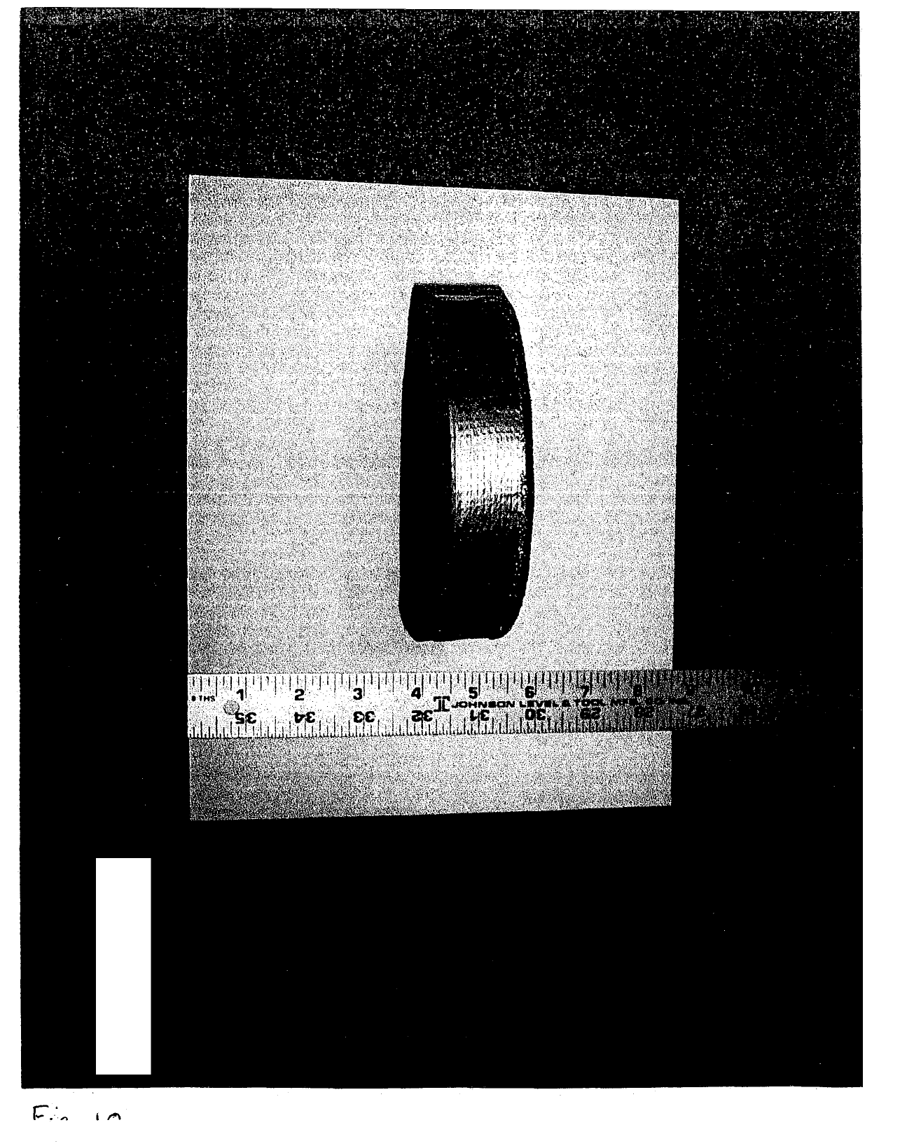

FIG. 11 is a digital photograph of the ring mute exposing the incision area where the rim of the brass musical instrument is placed

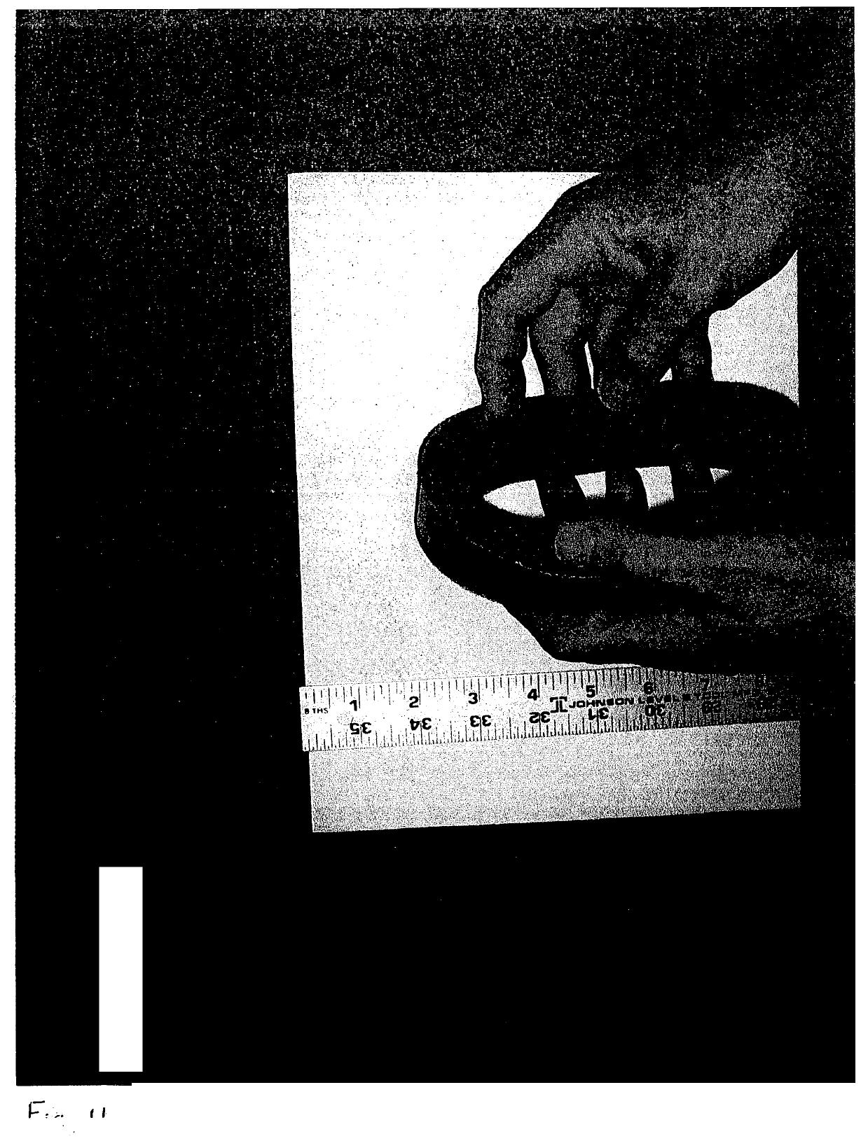

FIG. 12 is a digital photograph of a side view of the ring mute on the rim of the bell of a trupmet

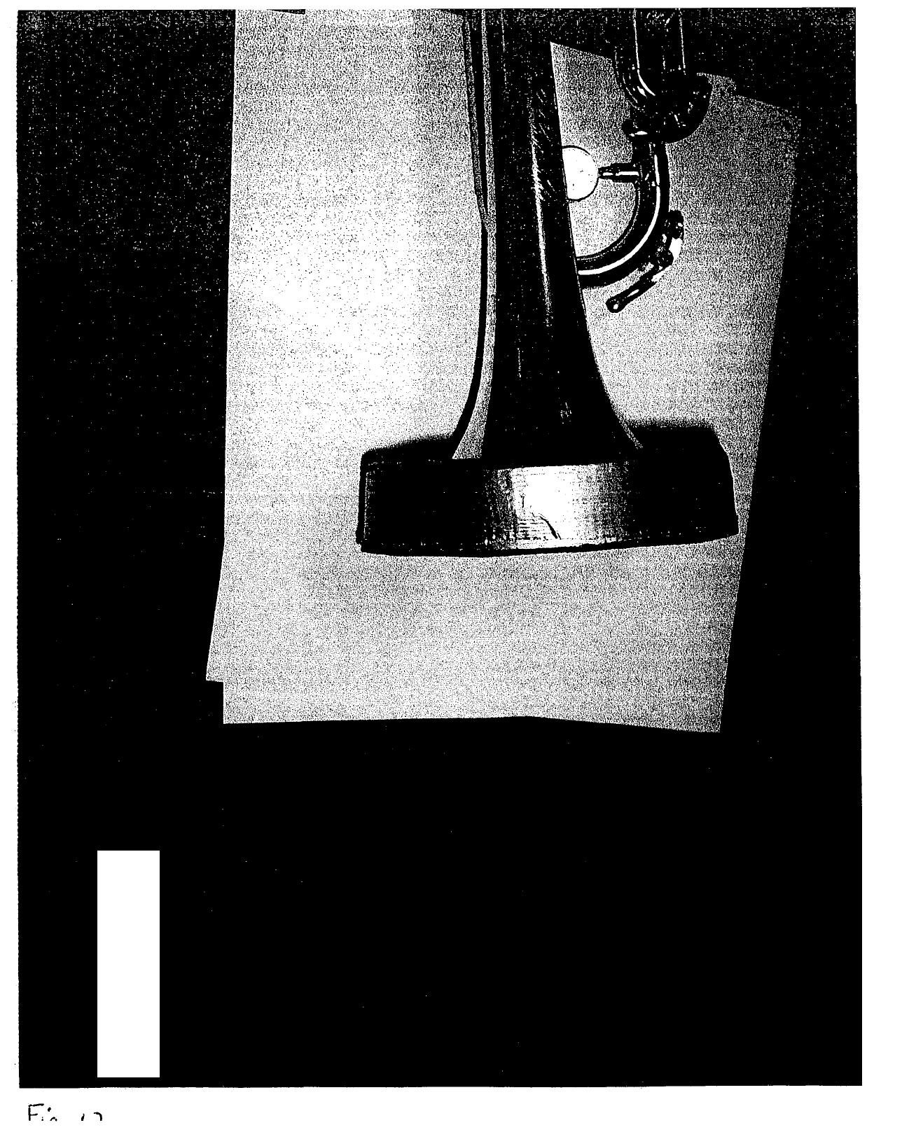

FIG. 13 is a digital photograph of the ring mute on the rim of the bell of a trumpet looking inside the bell of a trumpet

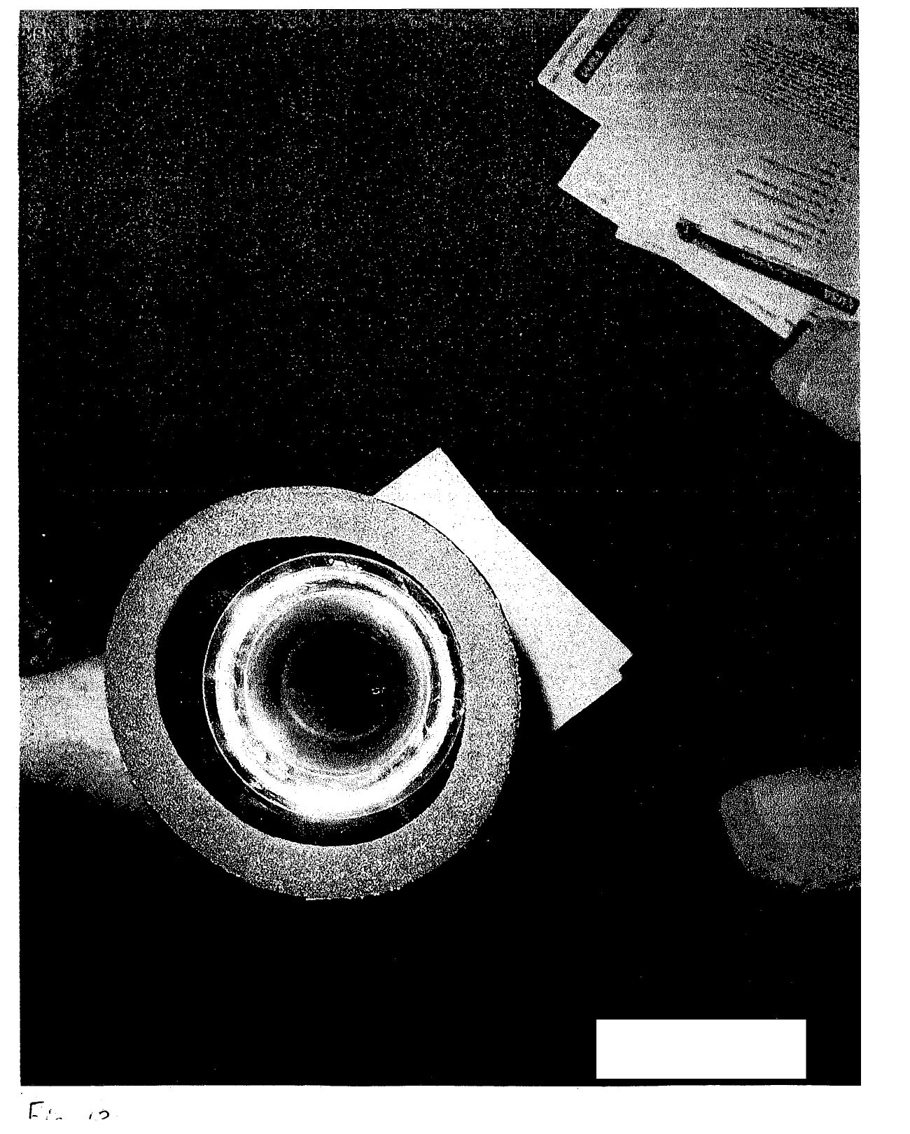

What is claimed is:

1) The ring mute is a mute that attaches onto and around the rim of the bell of a brass musical instrument, comprising:
a sound dampening absorbent flexible foam material with an adhesive strip attached to the outer surface of the ring; and a scalpel incision on the inside middle of the ring extending the entire middle circumference of the inner area of the ring.

2) The ring mute as set forth in claim 1, is a sound absorbent flexible urethane foam material ring 1.25 inches wide and 0.625 inches thick with a 0.25 deep scalpel incision extending the entire middle circumference of the inner area of the ring.

3) The ring mute as set forth in claim 1, by being attached onto and around the rim of the bell of a brass musical instrument instead of being placed into the bell of the brass musical instrument (as all other mutes are) causes no apparent air blow resistance.

4) The ring mute as set forth in claim 1, by being attached onto and around the rim of the bell of a brass musical instrument instead of being placed in the bell of the brass instrument causes no apparent change in pitch.

5) The ring mute as set forth in claim 1, possesses a flexible, non porous adhesive strip 1 inch wide inch attached to the outer area of the ring encircling the outer area of the ring

6) The ring mute as set forth in claim 1, dampens the sound causing the musical expressivity of a smooth, rounded and smoky sound.
